(19) United States
(12) Patent Application Publication
(10) Pub. No.: US 2014/0237371 A1
(43) Pub. Date: Aug. 21, 2014

(54) PRESENTATION PACING SYSTEM AND METHOD

(71) Applicant: AVAYA INC., Basking Ridge, NJ (US)

(72) Inventors: Reinhard P. Klemm, Basking Ridge, NJ (US); Doree Duncan Seligmann, New York, NY (US); John Yoakum, Cary, NC (US)

(73) Assignee: AVAYA INC., Basking Ridge, NJ (US)

(21) Appl. No.: 13/771,678

(22) Filed: Feb. 20, 2013

(51) Int. Cl. G06F 3/01

(52) U.S. Cl. CPC G06F 3/01
USPC 715/730

(57) ABSTRACT

A presentation pacing system includes a monitor module for monitoring a time spent by a speaker on one or more slides while presenting a presentation, the presentation having a plurality of slides. The presentation pacing system further includes a compare module for comparing the monitored time with a pre-recorded time associated with the slides. The presentation pacing system further includes a notification module for notifying the speaker for changing pace of the presentation based at least on the comparison. The presentation pacing system further includes a query module for scheduling and presenting queries of audience to the speaker of the presentation during a slide transition.

### BACKGROUND

1. Field of the Invention

Embodiments of the present invention generally relate to presenting a presentation and particularly to managing allocated time during the presentation.

2. Description of Related Art

Presentations have been integral part of every business. Typically, during a presentation, a speaker (or presenter) presents a slide show, and audience sit in front of him/her to follow the presentation. The audience may also include remote participants who follow the presentation through an audio or video conferencing system. Typically, the speaker of the presentation is given limited time for concluding the presentation so that other speakers can get their turns at time, the audience can also complete other daily professional works, and other daily works of the businesses can also be completed on time. However, during the limited time, the speaker has several kinds of presentation management tasks.

Conventionally, many presentation management tasks are normally handled by the speaker himself. During the presentation, the speaker compares the current time with a scheduled end time for the presentation, and determines whether to speed up or slow down remainder of the presentation. Often, the speaker forgets to do so and time overruns or underruns occur. Further, if the speaker starts late with the presentation, due to delays in a prior speaker schedule or otherwise, the speaker's anticipated timing of advancing through the presentation slides and other materials may no longer be valid. Hence, the speaker has to manually keep track of time spent for the presentation so far and the remaining time and pace him/herself through the remainder of the presentation accordingly.

Sometimes, the presentation management tasks are left for a master of ceremony (“MC”). The MC signals to the speaker through hand signals or flash cards or other mechanisms that only x minutes are left to complete the presentation. However, the speaker may not notice the signals or be caught by surprise by the unexpectedly quick progression of time and may have to scramble to complete the presentation. Further, the MC has to manually signal to the speaker when it is time to wrap up the presentation, or the speaker has to watch a countdown clock or other timing device.

Further, a member of the audience may have a question during the presentation and may want to interrupt the speaker with a question or observation. Normally, the best time for a speaker interruption is during a slide transition in the presentation because it is a naturally occurring break in the presentation flow during which a speaker interruption is less intrusive than during the speech. The audience also has a vivid memory of the most recent slides, which are likely to be the topic of the question or observation. However, if the audience is large and it is a member of the remote audience who wants to interrupt the speaker, it is very difficult to get the speaker's attention during the slide transition. Further, if several members of the remote audience have questions, scheduling their questions is an additional and difficult management task. One or more interruptions may impact timing of the presentation, which may lead to time overruns. Thus, interruptions should be allowed in the presentation as long as the overall timing of the presentation is not endangered. Similarly, at the end of the presentation there may be a few minutes left for questions that need to be properly scheduled so that no time overrun occurs and in a manner so that questions may be taken not just from the local but also from the remote audience.

The conventional practice for scheduling the questions is still completely manual and thus demands constant attention (and distraction) from the speaker and possibly the MC. Further, members of the remote audience typically get short shrift because they are not visible to the speaker or MC and thus it is unclear which members and how many members of the remote audience have questions, and giving them speaking rights in an orderly manner is extremely difficult. Further, the speaker or MC has to screen the local and remote audience for questions and observations throughout the presentation and at the end. Hence, the presentation management tasks distract the speaker even if they are partially performed by the MC, and often do not yield the desired results because they are carried out manually.

Some online conferencing systems provide messaging features that allow members of the audience to post questions to the speaker during or at the end of the presentation or provide thumbs-up or thumbs-down feedback at various times. However, to view audience messages, the speaker has to view the conferencing system rather than the presentation slides, which causes the speaker to switch back and forth between the presentation and the interface for the conferencing system.

Further, these conferencing systems lack automated scheduling of interruptions through members of the audience and scheduling of slide transitions. Furthermore, there is no integration between such messaging features and the slide show software, e.g., Microsoft PowerPoint.

Thus, there is a need for a system and method that can manage the presentation management tasks without distracting the speaker and further without support of the MC.

### SUMMARY

Embodiments in accordance with the present invention provide a presentation pacing system. The presentation pacing system includes a monitor module for monitoring a time spent by a speaker on each slide during presenting a presentation, the presentation having a plurality of slides. The presentation pacing system further includes a compare module for comparing the monitored time with a pre-recorded time associated with the slides. The presentation pacing system further includes a notification module for notifying the speaker for changing pace of the presentation based at least on the comparison. The presentation pacing system further includes a query module for scheduling and presenting audience queries to the speaker of the presentation.

Embodiments in accordance with the present invention further provide a computer-implemented method for pacing a speaker during a presentation. The method includes monitoring a time spent by the speaker on each slide during presenting a presentation, comparing the monitored time with a pre-recorded or estimated time associated with the slides, and notifying the speaker for changing pace of the presentation based at least on the comparison.

Embodiments in accordance with the present invention further provide a computer readable medium storing computer readable instructions when executed by a processor performing a method. The method includes monitoring a time spent by the speaker on each slide during presenting a presentation, comparing the monitored time with a pre-recorded time associated with the slides, and notifying the speaker for changing pace of the presentation based at least on the comparison.

Embodiments in accordance with the present invention can provide a number of advantages depending on the particular configuration. First, embodiments may pace a speaker of a presentation so that the speaker can complete the presentation in allotted amount of time.

Further, embodiments of the present invention enable a speaker to focus on presenting slides and rely on the presentation pacing system to pace her/him through the slides, even in the presence of interruptions from the audience. Neither the speaker nor a MC needs to be involved in finding out whether there are any questions during or at the end of the presentation because the system will notify the speaker of any desired interruptions by members of the audience, whether remote or local, but only as time allows. Further, members of the audience do not have to be shy about interrupting the speaker as the actual interruption will only occur at an opportune time (at slide transitions or at the end of the presentation) and only if there is enough time left. Further, the speaker is not interrupted during the active presentation phases (i.e., while presenting a slide). Further, members of the audience do not have to compete for being noticed by the speaker as the presentation pacing system receives all requests for speaker interruptions. Furthermore, there is less of a need for the speaker or an MC to manually find an equitable and fair distribution of time between members of the remote and local audience who wish to interrupt the speaker with a question or observation as the presentation pacing system will attempt a fair and equitable allocation of interruption time. Further, an MC does not have to try to get the attention of the speaker near the end of the presentation to alert the speaker to the remaining time for the presentation.

Further, embodiments of the present invention intelligently handle manual aspects of timing during a slide presentation by pacing a speaker through the presentation and managing speaker interruptions by members of the local and remote audience to keep the timing of the slide presentation on track, while distributing the limited time for question and answer (“Q&A”) fairly among those interested in interacting with the speaker. As such, it effectively moderates presentation-centric collaboration.

These and other advantages will be apparent from the disclosure of the present embodiments contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, embodiments in accordance with the present invention include a tangible storage medium or distribution medium and prior art-recognized equivalents and successor media, in which the software implementations of embodiments of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while embodiments of the present invention are described in terms of exemplary embodiments, it should be appreciated those individual aspects of the embodiments may be separately claimed.

The term “switch” or “server” as used herein should be understood to include a PBX, an ACD, an enterprise switch, or other type of communications system switch or server, as well as other types of processor-based communication control devices such as media servers, computers, adjuncts, web server, etc.

The preceding is a simplified summary of embodiments of the present invention, which provide an understanding of various embodiments of the present invention. This summary is neither an extensive nor exhaustive overview of the present invention and its various embodiments. It is intended neither to identify key or critical elements of embodiments of the present invention nor to delineate the scope of the present invention, but to present selected concepts of the present invention in a simplified form as an introduction to the more Detailed Description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following Detailed Description of embodiments thereof, especially when taken in conjunction with the accompanying drawings:

FIG. 1 illustrates an exemplary network environment where various embodiments of the present invention may be implemented;

FIG. 2 is a block diagram of modules, according to an embodiment of the present invention; and

FIGS. 3A, 3B, and 3C are collectively a flowchart depicting an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

Illustrative embodiments of the present invention now will be described more fully hereinafter with reference to the accompanying drawings, in which some, but not necessarily all embodiments of the present invention may be shown. Indeed, the present invention may be embodied in many different forms and should not be construed as limited to the embodiments set forth herein; rather, these embodiments may be provided so that this disclosure will satisfy applicable legal requirements. Like numbers refer to like elements throughout.

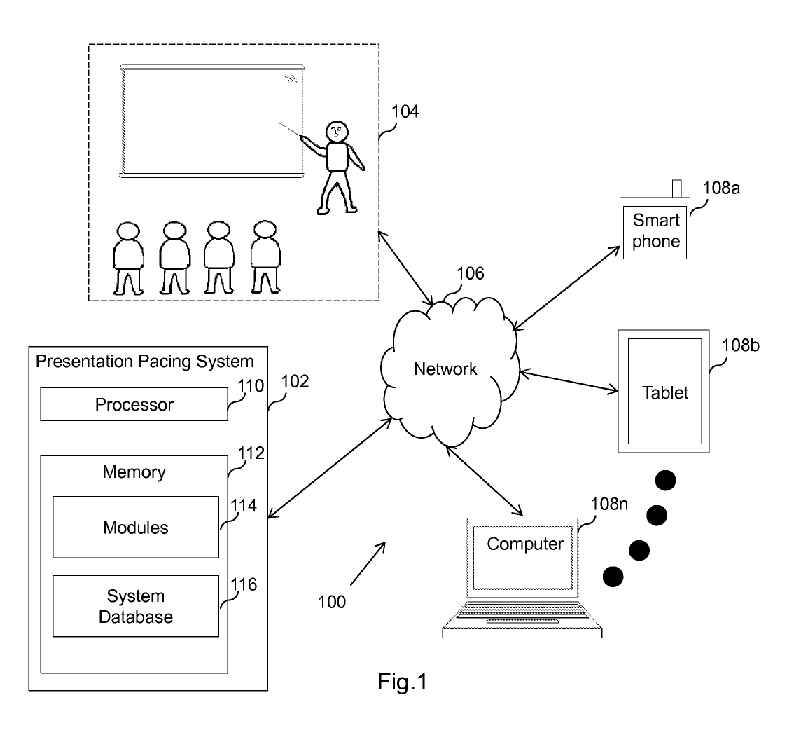

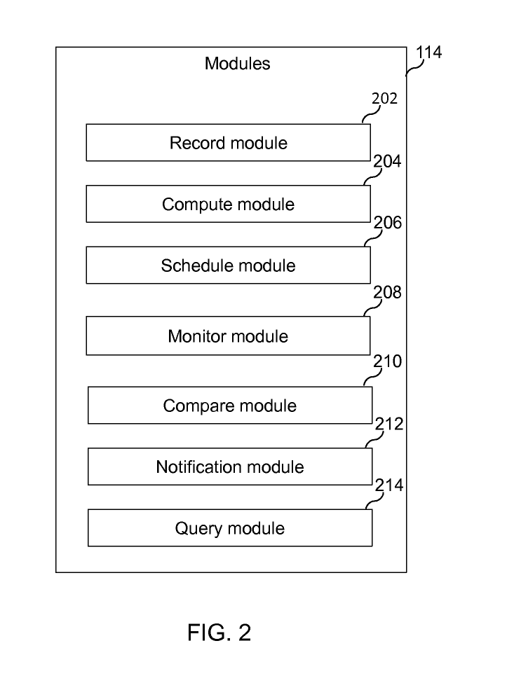

FIG. 1 illustrates an exemplary network environment 100 where various embodiments of the present invention may be implemented. The network environment 100 includes a presentation pacing system 102 connected to a speaker device 104 via a network 106. The speaker device 104 is an electronic device, wherein a speaker or presenter is presenting a presentation to audience. The speaker device 104 may be utilized by the speaker to receive notification about pace of the presentation from the presentation pacing system 102 and to receive a schedule of questions asked by the audience. The audience includes local audience and remote audience. The network environment 100 further includes a multiple of audience devices 108a, 108b . . . 108n connected to the presentation pacing system 102 via the network 106. The audience devices 108a, 108b . . . 108n (hereinafter may collectively be referred to as “audience devices 108”) may refer to electronic devices that may be utilized by audiences to access the presentation pacing system 102 to follow the presentation and register and/or ask questions from the speaker via the network 106. Examples of the audience devices 108 may include, but may be not restricted to, a personal computer, a mobile phone, a smart phone, a personal digital assistant (PDA), a tablet computer, a laptop, and the like. The Network 106 may include, but is not restricted to, a communication network such as Internet, PSTN, Local Area Network (LAN), Wide Area Network (WAN), Metropolitan Area Network (MAN), and so forth. In an embodiment, the network 106 can be a data network such as the Internet. Further, the messages exchanged between the presentation pacing system 102 and the audience devices 108, and further messages exchanged between the presentation pacing system 102 and the speaker device 104 can comprise any suitable message format and protocol capable of communicating the information necessary for the presentation pacing system 102 to provide pace of the presentation to the speaker devices 104 and provide schedule of the questions to the speaker.

In some embodiments, questions from audience members may be presented to the speaker in the order received, i.e., in a first-in, first-out queue. In other embodiments, the order in which questions are presented to the speaker may be rearranged in order to more efficiently answer questions, or to answer a greater number of questions, etc. For example, embodiments may use keyword or contextual analysis to identify similar or repeated questions so that they can be addressed together by the speaker. Other embodiments may use keyword or contextual analysis, or the length or the question itself, in order to estimate the time needed to answer the question. Questions may then be addressed out of order, depending upon the estimated time to answer. For example, toward an end of allotted time for Q&A, the speaker may decide to answer only questions that are judged to need a short response time to answer (e.g., those requiring a yes/no answer), and ask that audience members with longer questions or questions that are judged to require a long response time to answer discuss those questions with the speaker after the presentation.

Further, in an embodiment, the speaker device 104 may need to register with the presentation pacing system 102 for receiving notification about pace of the presentation and schedule of the questions in the network 106. Further, the audience of the audience devices 108 may need to register with the presentation pacing system 102 for being able to submit questions to the speaker during the presentation. The audience may be registered, to create a profile, by submitting information, such as personal information, profile information, company information and the like, to the presentation pacing system 102.

FIG. 1 Further illustrates exemplary block diagram of a system, such as the presentation pacing system 102, in accordance with an embodiment of the present invention. In one embodiment, the presentation pacing system 102 may be a computing device. In an embodiment, the presentation pacing system 102 may be utilized for pacing presentation by the speaker and scheduling questions asked by the audience devices 108. The presentation pacing system 102 includes a processor 110 and a memory 112. In one embodiment, the processor 110 includes a single processor and resides at the presentation pacing system 102. In another embodiment, the processor 110 may include multiple sub-processors and may reside at the presentation pacing system as well as the speaker device 104 and/or audience devices.

Further, the memory 112 includes one or more instructions that may be executed by the processor 110 to notify the user about pace of the presentation and scheduling questions asked by the audiences. In one embodiment, the memory 112 includes modules 114, a system database 116, and other data (not shown in FIG. 1). The system database 116 may include login credentials of substantially all participants involved in the database. The other data may include various data generated during pacing the presentation and scheduling of questions. In one embodiment, the system database 116 is stored internal to the presentation pacing system 102. In another embodiment, the system database 116 may be stored external to the presentation pacing system 102, and may be accessed via the network 106. Furthermore, the memory 112 of the presentation pacing system 102 is coupled to the processor 110.

The modules 114 include a record module 202, a compute module 204, a schedule module 206, a monitor module 208, a compare module 210, a notification module 212, and a query module 214. The presentation pacing system 102 is configured to notify the presenter about pace of the presentation and schedule questions for the speaker at the speaker device asked by the audiences.

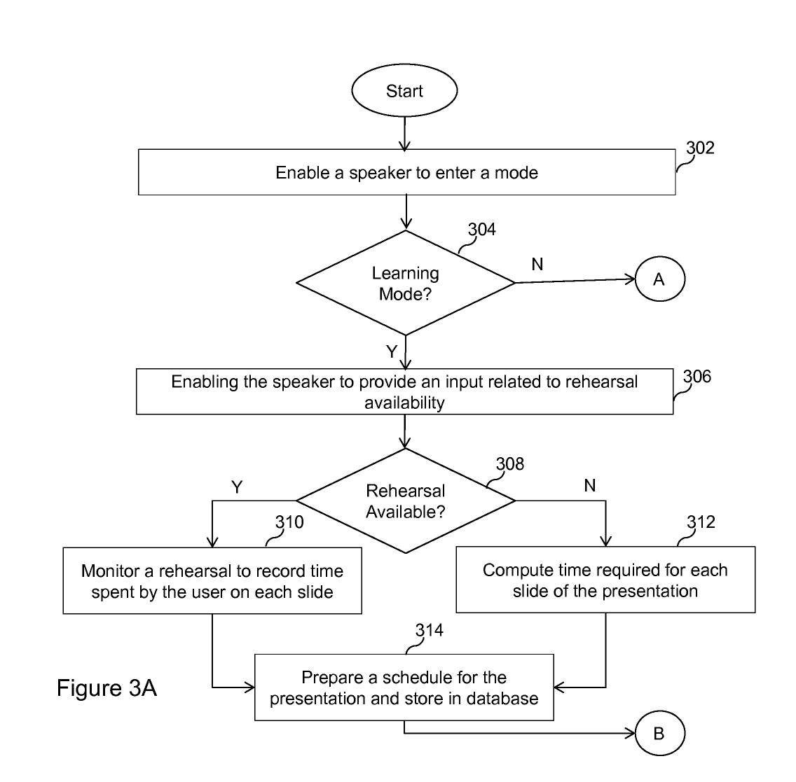

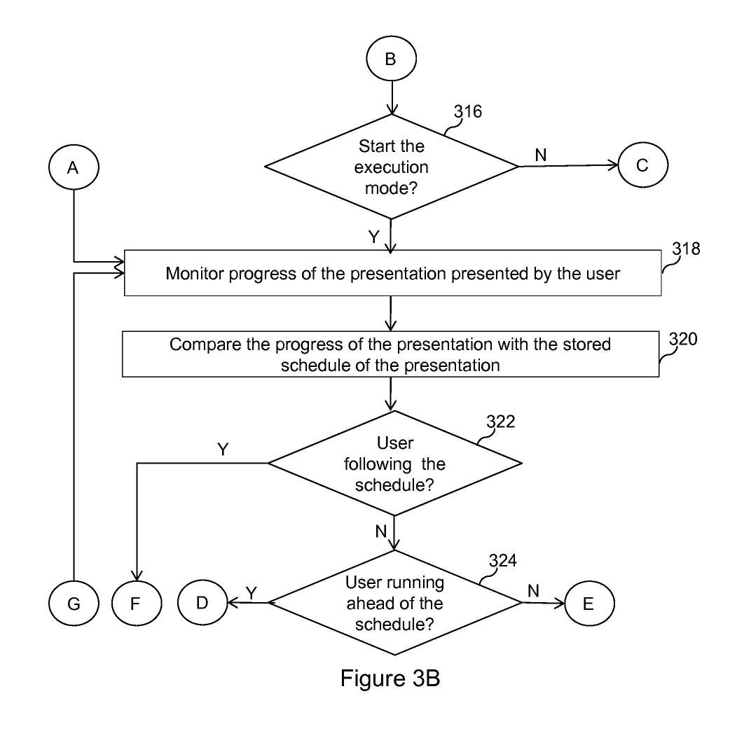

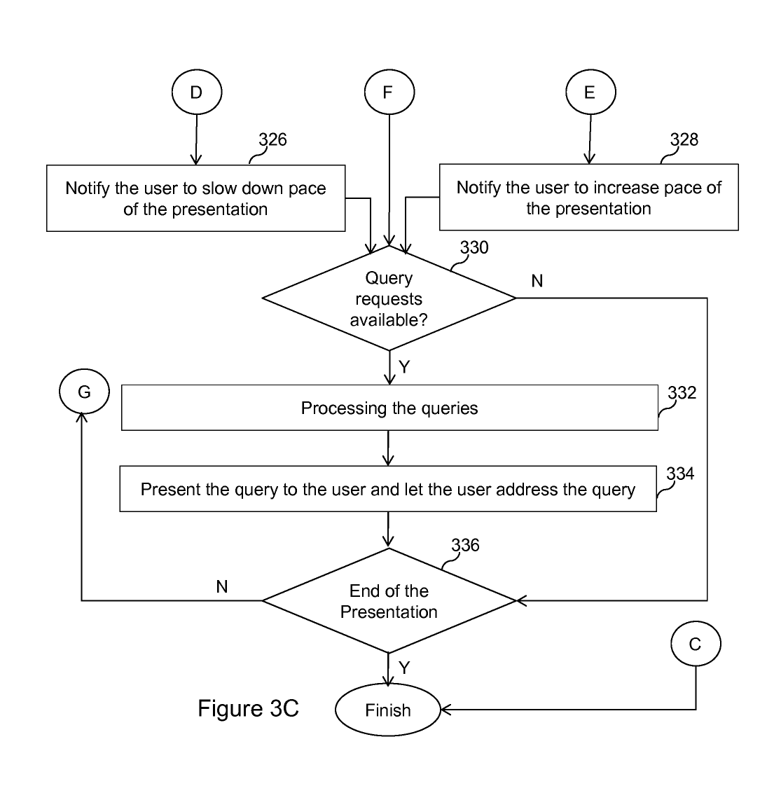

The operation of the record module 202, the compute module 204, the schedule module 206, the monitor module 208, the compare module 210, the notification module 212, and the query module 214, will now be discussed with reference to FIGS. 3A, 3B and 3C.

In an embodiment, the speaker may be asked to enter his/her login credentials into the presentation pacing system 102. The login details entered may be compared with login details stored in the system database 116. Based upon successful login, the speaker may be given access to the presentation pacing system 102. In some embodiments, the audience may also need to register and/or log in to the presentation pacing system 102 at least in order to gain certain benefits or privileges, such as permission to submit questions to the speaker.

In step 302, the presentation pacing system 102 enables a speaker to enter a mode. In an embodiment, the presentation pacing system 102 includes two modes i.e., a learning mode and an execution mode. In an embodiment, the speaker may enter ‘L’ for the learning mode or ‘E’ for the execution mode.

In the learning mode, the presentation pacing system 102 sets guidelines required to be followed by the speaker. In the execution mode, the presentation pacing system 102 monitors progress of the speaker in the presentation against guidelines set in the learning mode, and notifies the speaker for changing pace of the presentation, if required. The presentation pacing system 102 further schedules questions asked by the audience (local as well as remote) for the presenter and presents the questions to the speaker.

In step 304, it is determined by the presentation pacing system 102 whether it is a learning mode. In an embodiment, if the speaker enters ‘L’, the presentation pacing system 102 starts the learning mode, and if the speaker enters ‘E’, the presentation pacing system 102 starts the execution mode.

If system 102 is the learning mode, the presentation pacing system 102, at step 306, enables the speaker to provide an input related to rehearsal availability. In an embodiment, the presentation pacing system 102 may set guidelines for the speaker based on rehearsal of the presentation. In another embodiment, the presentation pacing system 102 may set guidelines for the speaker based on text or other content of the presentation, or data provided by the speaker.

In step 308, it is determined by the presentation pacing system 102 whether the rehearsal is available. If the rehearsal is available, the record module 202, at step 310, monitors the rehearsal to record time spent by the speaker on each slide. In an embodiment, the presentation pacing system 102 integrates with a presentation software (e.g., Microsoft PowerPoint or any visual presentation system) used by the speaker. For each slide in the presentation, the record module 202 records how long the speaker dwelled on this slide.

In case the rehearsal is not available, the compute module 204, at step 312, computes total time required by the speaker to complete the presentation. In an embodiment, the compute module 204 computes total time required by the speaker based on one or more metrics such as number of slides, number of words, the number of bullet items, number of pictures, number of graphs, and so forth. Additional metrics may be useful depending upon the content of the presentation, such as whether the presentation includes audio/video content.

In another embodiment, the speaker may rehearse only an abbreviated portion of the presentation (e.g., the first half or first quarter). The compute module 204 may make a projection based on the abbreviated portion of the rehearsal. The compute module 204 may calculate total time required for the presentation based on time required to rehearse the abbreviated portion. For example, the compute module 204 may compute total time required for the presentation by simply doubling time required in the first half or quadrupling time required in the first quarter. In general, if a portion ρ is rehearsed by the speaker (0<ρ1), the projected time to present the entire presentation may be calculated as: (projected time)=(rehearsal time)/ρ.

The portion ρ may be calculated by compute module 204 based upon metrics such as a percentage of the total number of slides in the presentation that were rehearsed, or a percentage of the total number of words in the presentation that were rehearsed, or a percentage of the total number of bullet items in the presentation that were rehearsed, or a percentage of the total number of figures in the presentation that were rehearsed, or combinations thereof, and so forth, based upon relevant metrics. Bullet items and/or figures may provide an entry point for Q&A by audience members, so an estimate of the time needed for audience interaction may be different when using different metrics to measure portion ρ. For example, a given number of words spread across less wordy slides (measured by a ratio of words per bullet item) may invite more audience interaction or ad-libbing by the speaker than the same number of words spread across comparatively more wordy slides. Historical norms may be used to estimate the time needed for audience interaction.

Projected times based upon a relatively small abbreviated portion of the presentation (i.e., ρ closer to 0) may have greater associated uncertainty than projected time based upon a relatively large abbreviated portion of the presentation (i.e., ρ closer to 1). Uncertainty may be based upon historical norms, and/or based upon variations in the speaker's own pace (e.g., if slides two and three are substantially the same based on a metric such as the number of words or number of bullets, yet one slide took 25% longer to present than the other slide). Therefore, as the speaker rehearses the presentation, the associated uncertainty in the projected time decreases as ρ increases from ρ=0 to ρ=1. During rehearsal, an estimated uncertainty based upon the present value of ρ may be shown to the speaker, and the speaker may make a judgment as to whether the estimated uncertainty is sufficiently small as to justify stopping the rehearsal. For example, the present value of ρ may be presented to the speaker by substantially any method such as a percentage, graphical progress bar, etc., and the projected time may be presented with its statistical uncertainty, such as a mean time +/− one standard deviation.

Further, in an embodiment, the speaker may enter a total time allocated to him for concluding the presentation. For example, the presenter may be given half an hour for completing the presentation at one meeting, while full hour for completing the presentation at another meeting. The compute module 204 may associate time with each slide of the presentation based on metrics such as number of words, the number of bullet items, number of pictures, number of graphs, etc., alone or in any combination. The compute module 204 may further scale up or scale down time associated with each slide based on allocated time given to the speaker in a meeting.

In step 314, the schedule module 206 prepares a schedule of the presentation. In an embodiment, the schedule module 206 may note time recorded by the record module 202 for each slide and make a sequence of these timings to prepare a schedule for the presentation. In another embodiment, the schedule module 206 may note time recorded by the record module 202 for each slide, add some time (for example, a fixed or predetermined percentage) into the noted time and make a sequence of these timings to prepare a schedule for the presentation. The added time may be useful to allow for unscripted events such as Q&A. Those skilled in the art will appreciate that the schedule of the presentation thus formed does not match completely to the rehearsal timings. This is because, under a rehearsal, if the presenter spends 20 seconds for slide 19, then, in the actual presentation, the speaker may require a minute or 40 seconds for the slide 19.

The schedule module 206 utilizes rehearsal time and/or computation of required time for setting guidelines for the speaker.

In step 316, the presentation pacing system 102 asks the speaker whether to start the execution mode. In an embodiment, the speaker may be presenting the actual presentation just after the rehearsal. In another embodiment, the speaker may be presenting the actual presentation to the audiences some time after the rehearsal. In case, the speaker enters an input not to start the execution mode (or the speaker does not provide any input), the method 300 is concluded. Otherwise, if the speaker enters an input to start the execution mode, the method 300 proceeds towards step 318.

Also, if at step 304, if it is determined by the presentation pacing system 102 based on the speaker's input, that it is execution mode, the method 300 proceeds towards step 318.

In step 318, the monitor module 208 monitors progress of the presentation presented by the speaker. In an embodiment, the monitor module 208 monitors progress of the speaker through the slides. If the speaker has presented half number of slides from total number of slides, the monitor module 208 may note that half of the presentation has been completed. In another embodiment, the monitor module 208 may utilize metrics such as number of slides, number of words, number of bullet points, number of graphs, etc. in computing progress of the presentation. In yet another embodiment, the monitor module 208 may utilize same process as followed by the record module 202 in computing progress of the presentation.

In step 320, the compare module 210 compares the progress of the presentation with the stored schedule of the presentation. In step 322, it is determined by the compare module 210 whether the speaker is following the schedule. In case, the speaker is not following the schedule, the compare module 210, in step 324, determines whether the speaker is running ahead of the schedule.

In case the speaker is running ahead of the schedule, the notification module 212, at step 326, sends a notification to the speaker for slowing down pace of the presentation. The method 300 further proceeds towards step 330. In an embodiment, if the speaker is more than a configured percentage fast relative to the recorded schedule from the learning mode, the notification module 212 shows a notification that tells the speaker that she/he can slow down.

Otherwise, if the speaker is running behind the schedule, the notification module 212, in step 328, sends a notification to the speaker for increasing pace of the presentation. In an embodiment, if the speaker falls more than a configured percentage behind the recorded schedule, the notification module 212 shows a notification on/near the current slide that tells the speaker to speed up the presentation.

In one embodiment, the notification comprises a pop-up, icon or text. In another embodiment, the notification may include a whisper that only the speaker can hear. In yet another embodiment, the notification may include a progress bar located at top or bottom of each of the current slide of the presentation.

In an embodiment, the notification module 212 may utilize a series of lights or other indicators for notifying the speaker about the pace of the presentation. For example, the notification module 212 may display a red light at screen of a current slide to notify the user to change the pace of the presentation (either faster or slower). A directional indicator (e.g., “+” or “−”, an arrow, a meter, etc.) may be used to indicate whether to speed up or slow down. Further, the notification module 212 may display a green light at screen of a current slide to notify the user that he is following the schedule of the presentation to within a predetermined tolerance. Furthermore, the notification module 212 may display a yellow light at screen of a current slide to notify the user that he is just within boundaries of the schedule. In another embodiment, the series of lights may be presented to the speaker as, e.g., a green bar-graph and a red bar-graph. Assuming that being ahead of schedule is preferable to being behind of schedule, if the speaker is ahead of the pace then at least a portion of the green bar-graph may be lit, with more green bars lit as the speaker is further ahead of the pace. Conversely, if the speaker is behind of the pace, at least a portion of the red bar-graph may be lit, with more red bars lit as the speaker is further behind of the pace. In another embodiment, a digital clock display may be used to estimate the amount of time that the speaker is ahead or behind the pace.

The method 300 further proceeds towards step 330. In case, at step 322, it is determined by the compare module 210 that the speaker is following the schedule to within a predetermined tolerance (e.g., within 1 minute of the schedule, or within 5% of the schedule, etc.), the method proceeds directly to step 330. In some embodiments, the predetermined tolerance may be configurable during operation. In other embodiments, the predetermined tolerance may be configured just once, such as during manufacture or installation.

In step 330, the query module 214 determines whether query requests are available. In an embodiment, the presentation pacing system 102 provides an interface to each member of the audience including local audience or remote audience to send a request for an interruption or posing a question for the speaker. In an embodiment, the interface includes a user-activatable control on screen of the audience device 108, which allows the audience to alert the presentation pacing system 102 that he/she has a question or a comment. Those skilled in the art will appreciate that the interface provides a way for audience members to register their questions, so that their questions are at least noticed by the presentation pacing system 102.

Further, in an embodiment, the presentation pacing system 102 automatically conveys slide transitions to the remote audience. The remote audience may ask their questions or register their questions with the presentation pacing system 102 at any time but the speaker will receive a notification from the system about questions only during the slide transitions and at the end of the presentation.

If the query requests are not available (e.g., nobody has a question to ask), the method 300 proceeds towards step 336. Otherwise, if the query requests are available, the query module 214, at step 332, processes the queries. In an embodiment, the audience may register their query requests with the presentation pacing system 102, and the query module 214 may forward those queries to the speaker based on first come first serve, when the speaker is within the boundaries of the schedule or following the schedule. In another embodiment, the query module 214 may allow equal number of questions from both of the local audience and remote audience. For example, questions from the local audience and remote audience may be taken on alternate basis. In yet another embodiment, the query module 214 processes the queries to determine which question from the audience should be allowed or forwarded to the speaker. In an embodiment, a question may be forwarded to the speaker based on time required for answering that particular question. For example, questions whose answers are ‘yes’ or ‘no’ may be forwarded first to the speaker in order to answer as many questions as possible. In other embodiments, the content of questions may be analyzed by keyword analysis or the like, and similar questions may be presented to the speaker together so that they can be answered together.

Further, the query module 214 is configured to determine how long the question may be addressed by the speaker. The query module 214 ensures that only as many questions are allowed from the audiences, as time slot will accommodate or so long the speaker is following the schedule (within boundaries of the schedule). In some embodiments, questions that are likely to require longer answers may be scheduled first so that there is adequate time to answer the question. In some embodiments, toward an end of an allotted time for question and answer, questions having shorter answers or yes/no answers may be answered in order to answer more questions in the remaining time. The system will email all audience questions and observations that were registered with the system but for which there was insufficient time to respond during the presentation to the speaker after the presentation. Alternatively, the speaker can look up all registered questions in the system after the presentation.

At step 334, the query module 214 presents a query to the user and the user addresses the query. In an embodiment, at time of next slide transition, the query module 214 compares remaining time allocated for the presentation with the current presentation progress. If there is enough time left in the schedule relative to the recorded schedule, the query module 214 notifies the speaker of a pending request for an interruption. The notification includes a popup in current slide of the presentation with an “Accept” and a “Reject” button. If the speaker ignores the popup, the presentation pacing system 102 interprets this as a “Reject”. If the speaker presses, “Accept”, the presentation pacing system 102 allows the interruption/question by signaling right to speak to the requestor's interface.

During interaction of the requestor with the speaker, the presentation pacing system 102 monitors progression of time against the recorded schedule. If the duration of the interaction, added to the time at the beginning of the interaction, exceeds the reference point in time in the recorded schedule for the current slide, the presentation pacing system 102 displays a warning to both the speaker and requestor. If not, the presentation pacing system 102 allows next requestor to proceed with a question or an observation, if there is another requestor. In an embodiment, the presentation pacing system 102 utilizes a first-come-first-served policy for giving requestors speaking rights, drawing from both local and remote audiences. Further, the presentation pacing system 102 may give lower priority to requestors who had been given speaking rights before.

Further, in an embodiment, if the presentation has entered its final ‘X’ minutes (where x is a configurable value), the presentation pacing system 102 is configured to show more prominent reminders of the remaining time to the speaker in form of larger/more visible notifications (e.g., pop-ups) with the remaining time in minutes shown.

At step 336, it is determined by the presentation pacing system 102 whether it is end of the presentation. In case, it is end of the presentation, the method 300 concludes. In an embodiment, at the end of the presentation, the presentation pacing system 102 permit questions from the audiences as during slide transitions, if time allows. In another embodiment, the presentation pacing system 102 allows some percentage (up to 100%) of any question time originally allocated, at the slide transitions, and allowing whatever time is still remaining (if any) to be utilized at the end of the presentation.

Otherwise, the method 300 returns to step 318, and continues monitoring the progress of the presentation.

The exemplary systems and methods of embodiments of the present invention have been described in relation to a presentation participant's environment. However, to avoid unnecessarily obscuring the present embodiments, the preceding description omits a number of known structures and devices. This omission is not to be construed as a limitation of the scope of the claimed invention. Specific details are set forth to provide an understanding of embodiments of the present invention. It should however be appreciated that embodiments of the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of embodiments of the present invention.

A number of variations and modifications of the present invention can be used. It may be possible to provide for some features of embodiments of the present invention without providing others.

For example in one alternative embodiment, the systems and methods of this present invention may be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this present invention. Exemplary hardware that can be used for the present embodiment includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present embodiment is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods embodiments of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although embodiments of the present invention describe components and functions implemented in the embodiments with reference to particular standards and protocols, the embodiments are not limited to such standards and protocols. Other similar standards and protocols not mentioned herein are in existence and are considered to be included in embodiments of the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in embodiments of the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of embodiments of the present invention has been presented for purposes of illustration and description. The foregoing is not intended to limit the present invention to the embodiments disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A presentation pacing system, comprising:
a monitor module configured to monitor a time spent by a speaker on one or more slides while presenting a presentation, the presentation comprising a plurality of slides;
a compare module configured to compare the monitored time with a pre-recorded time associated with the slides; and
a notification module configured to notify the speaker to change a pace of the presentation based at least on the comparison.

2. The presentation pacing system of claim 1, wherein the notification module is configured to notify a user to slow down a pace of the presentation if the pre-recorded time exceeds the monitored time by more than a predetermined tolerance.

3. The presentation pacing system of claim 1, wherein the notification module is configured to notify a user to increase a pace of the presentation if the pre-recorded time is less than the monitored time by more than a predetermined tolerance.

4. The presentation pacing system of claim 1, further comprising a record module configured to record a time spent by the speaker on one or more slides of the presentation during a rehearsal.

5. The presentation pacing system of claim 1, further comprising a query module configured to present queries from an audience to the speaker of the presentation during a slide transition.

6. The presentation pacing system of claim 5, wherein the query module is further configured to present the queries to the speaker based on first come first serve.

7. The presentation pacing system of claim 5, wherein the query module is configured to notify the speaker in case the duration of interaction with a query requestor exceeds a recorded schedule.

8. A computer-implemented method to pace a speaker during a presentation, the method comprising:
monitoring a time spent by the speaker on one or more slides while presenting a presentation;
comparing the monitored time with a pre-recorded time associated with the one or more slides; and
notifying the speaker to change a pace of the presentation based at least on the comparison.

9. The computer-implemented method of claim 8, wherein the step of notifying comprises notifying the speaker to slow down the pace of the presentation if the pre-recorded time exceeds the monitored time by more than a predetermined tolerance.

10. The computer-implemented method of claim 8, wherein the step of notifying comprises notifies a user to increase a pace of the presentation if the pre-recorded time is less than the monitored time by more than a predetermined tolerance.

11. The computer-implemented method of claim 8, further comprising presenting queries from an audience to the speaker during a slide transition.

12. The computer-implemented method of claim 8, further comprising associating a training run time with one or more slides of the presentation during a rehearsal.

13. The computer-implemented method of claim 8, further comprising integrating the presentation pacing system with a visual presentation system.

14. The computer-implemented method of claim 8, wherein the wherein the visual presentation system comprises a power point presentation system.

15. A tangible computer readable medium storing computer readable instructions that, when executed by a processor, perform a method comprising:
monitoring a time spent by a speaker on one or more slides while presenting a presentation;
comparing the monitored time with a pre-recorded time associated with slides of the presentation; and
notifying the speaker to change a pace of the presentation based at least on the comparison.
